(19) United States
(12) Patent Application Publication
(10) Pub. No.: US 2012/0102916 A1
(43) Pub. Date: May 3, 2012

(54) Pulse Detonation Combustor Including Combustion Chamber Cooling Assembly

(75) Inventor: Ronald Scott Bunker, Waterford, NY (US)

(73) Assignee: GENERAL ELECTRIC COMPANY, Schenectady, NY (US)

(21) Appl. No.: 12/915,544

(22) Filed: Oct. 29, 2010

(51) Int. Cl. F02K 5/02

(52) U.S. Cl. 60/247

(57) ABSTRACT

A pulse detonation combustor including a combustion chamber and a cooling assembly circumscribing the combustion chamber. The cooling assembly is configured to provide a flow of cooling fluid therethrough and provide cooling of the combustion chamber. The cooling assembly includes a cooling flow sleeve positioned about the combustion chamber. The cooling flow sleeve includes a plurality of circumferentially spaced apart axially extending structural members defining a plurality of flow passages therebetween. The cooling assembly is configured mechanically and thermally separate from the combustion chamber and provides axisymmetric cooling to the combustion chamber.

### BACKGROUND

The present disclosure generally relates to cyclic pulsed detonation combustors (PDCs) and more particularly, to pulse detonation combustion chambers and cooling of pulse detonation combustion chambers.

In a generalized pulse detonation combustor, fuel and oxidizer (e.g., oxygen-containing gas such as air) are admitted to an elongated combustion chamber at an upstream inlet end. An igniter is used to initiate this combustion process. Following a successful transition to detonation, a detonation wave propagates toward the outlet at supersonic speed causing substantial combustion of the fuel/air mixture before the mixture can be substantially driven from the outlet. The result of the combustion is to rapidly elevate pressure within the combustor before substantial gas can escape through the combustor exit. The effect of this inertial confinement is to produce near constant volume combustion. Such devices can be used to produce pure thrust or can be integrated in a gas-turbine engine. The former is generally termed a pure thrust-producing device and the latter is termed a pulse detonation turbine engine. A pure thrust-producing device is often used in a subsonic or supersonic propulsion vehicle system such as rockets, missiles and afterburner of a turbojet engine. Industrial gas turbines are often used to provide output power to drive an electrical generator or motor. Other types of gas turbines may be used as aircraft engines, on-site and supplemental power generators, and for other applications.

The deflagration-to-detonation process begins when a fuel-air mixture in a pulse combustion chamber is ignited via a spark or other source. The subsonic flame generated from the spark accelerates as it travels along the length of the chamber due to various chemical and flow mechanics. As the flame reaches critical speeds, “hot spots” are created that create localized explosions, eventually transitioning the flame to a super sonic detonation wave. The DDT process may result in extreme temperatures within the pulse combustion chamber. Prior combustor cooling designs include film cooling which involves introducing relatively cool compressor air into a plenum surrounding the outside of the combustor. In this prior arrangement, the air from the plenum passes as a film over the inner surface of the combustor liner, thereby maintaining combustor liner integrity. In combustor designs where film cooling is not desired or practical, such as with pulse combustion chambers, cooling has been achieved through backside cooling with a combination of convective and/or impingement flows. Other means include the use of surface augmentation features, an example of which is turbulators on the combustor liner. While these forms of cooling are somewhat adequate, there exists a need to provide for cooling of a pulse detonation combustion chamber that may additionally allow for a reduction in the overall size of the combustion chamber, while assuring that the combustion chamber can withstand the high pressure of detonations and the cyclic duty load of the pulsed detonations. In addition, there exist a need to provide for cooling of the combustion chamber that is cost effective, easily repaired and/or replaced.

As used herein, a “pulse detonation combustor” is understood to mean any device or system that produces pressure rise, temperature rise and velocity increase from a series of repeating detonations or quasi-detonations within the device. A “quasi-detonation” is a supersonic turbulent combustion process that produces pressure rise, temperature rise and velocity increase higher than pressure rise, temperature rise and velocity increase produced by a deflagration wave. Embodiments of pulse detonation combustors include a fuel injection system, an oxidizer flow system, a means of igniting a fuel/oxidizer mixture, and a combustion chamber, in which pressure wave fronts initiated by the ignition process coalesce to produce a detonation wave or quasi-detonation. Each detonation or quasi-detonation is initiated either by external ignition, such as spark discharge or laser pulse, or by gas dynamic processes, such as shock focusing, autoignition or by another detonation (cross-fire). As used herein, a detonation is understood to mean either a detonation or quasi-detonation. The geometry of the detonation combustor is such that the pressure rise of the detonation wave expels combustion products out the pulse detonation combustor exhaust to produce a thrust force. Pulse detonation combustion can be accomplished in a number of types of combustion chambers, including shock tubes, resonating detonation cavities and tubular/tuboannular/annular combustors. As used herein, the term “chamber” includes pipes having circular or non-circular cross-sections with constant or varying cross sectional area. Exemplary chambers include cylindrical tubes, as well as tubes having polygonal cross-sections, for example hexagonal tubes.

### BRIEF SUMMARY

Briefly, in accordance with one embodiment, a pulse detonation combustor is provided. The pulse detonation combustor includes a combustion chamber and a cooling assembly circumscribing said combustion chamber and providing a flow of cooling fluid therethrough. The cooling assembly is configured mechanically and thermally separate from the combustion chamber and provides axisymmetric cooling to the combustion chamber.

In accordance with another embodiment, a pulse detonation combustor is provided. The pulse detonation combustor includes a combustion chamber and a cooling assembly circumscribing said combustion chamber and providing a flow of cooling fluid therethrough. The cooling assembly includes a cooling flow sleeve concentrically aligned with the combustor chamber and having a plurality of circumferentially spaced apart axially extending structural members defining a plurality of flow passages therebetween. The cooling assembly is configured mechanically and thermally separate from the combustion chamber and provides axisymmetric cooling to the combustion chamber.

In accordance with another embodiment, a pulse detonation combustor assembly is provided. The pulse detonation combustor assembly includes at least one combustion chamber; an oxidizer supply section for feeding an oxidizer into the combustion chamber; a fuel supply section for feeding a fuel into the combustion chamber; and an igniter for igniting a mixture of the gas and the fuel in the combustion chamber, and a cooling assembly circumscribing said combustion chamber and providing a flow of cooling fluid therethrough, the cooling assembly including a cooling flow sleeve concentrically aligned with the combustor chamber and having a plurality of circumferentially spaced apart axially extending structural members defining a plurality of flow passages therebetween. The cooling assembly is configured mechanically and thermally separate from the combustion chamber and provides axisymmetric cooling to the combustion chamber.

### BRIEF DESCRIPTION OF THE DRAWINGS

Referring to the exemplary drawings wherein like elements are numbered alike in the several Figures:

FIG. 1 is a schematic view illustrating a structure of a hybrid pulse detonation turbine engine system;

FIG. 2 is a schematic view illustrating a structure of a single combustion chamber of the pulse detonation combustor of FIG. 1;

FIG. 3 is a diagram illustrating an improved pulse detonation combustor including a combustion chamber and cooling assembly in accordance with an exemplary embodiment;

FIG. 4 is a diagram illustrating an improved pulse detonation combustor including a combustion chamber and a cooling assembly in accordance with an exemplary embodiment;

FIG. 5 is a schematic cross-section view taken along line 5-5 of FIG. 4 illustrating the pulse combustion chamber and cooling assembly during a cold phase of operation;

FIG. 6 is a schematic cross-section view taken along line 5-5 of FIG. 4 illustrating partial thermal expansion of the pulse combustion chamber;

FIG. 7 is a schematic cross-section view taken along line 5-5 of FIG. 4 illustrating complete thermal expansion of the pulse combustion chamber;

FIG. 8 is an elevational view illustrating an exemplary embodiment of a shaped rib-like structure of the cooling assembly in accordance with an exemplary embodiment;

FIG. 9 is an elevational view illustrating an exemplary embodiment of a shaped rib-like structure of the cooling assembly in accordance with an exemplary embodiment;

FIG. 10 is an elevational view illustrating an exemplary embodiment of a shaped rib-like structure of the cooling assembly in accordance with an exemplary embodiment;

FIG. 11 is an elevational view illustrating an exemplary embodiment of a shaped rib-like structure of the cooling assembly in accordance with an exemplary embodiment;

FIG. 12 are schematic representations of a plurality of configurations for the rib-like structures in accordance with an exemplary embodiment;

FIG. 13 is a schematic representation of a configuration for the plurality of rib-like structures in accordance with an exemplary embodiment;

FIG. 14 is a schematic cross-section view taken along line 5-5 of FIG. 4 illustrating a shaped exterior surface of the combustion chamber;

FIG. 15 is a close up view of a plurality of cast turbulators that may form the shaped exterior surface of FIG. 14;

FIG. 16 is a close up view of a plurality of brazed turbulators that may form the shaped exterior surface of FIG. 14; and

FIG. 17 is a close up view of a plurality of wirespray turbulators that may form the shaped exterior surface of FIG. 14.

### DETAILED DESCRIPTION

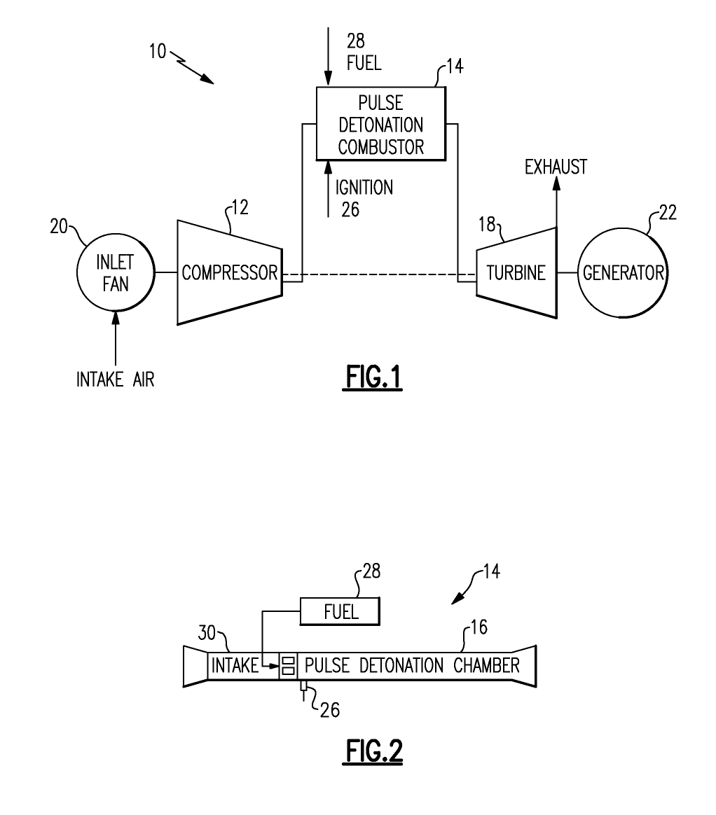

Referring now to FIGS. 1 and 2, various pulse detonation engine systems 10 convert kinetic and thermal energy of the exhausting combustion products into motive power necessary for propulsion and/or generating electric power. Illustrated in FIG. 1 is an exemplary embodiment of a pulse detonation combustor 14 in a pulse detonation turbine engine concept 10. Illustrated in FIG. 2 is an exemplary embodiment of a pulse detonation combustor 14 in a pure supersonic propulsion vehicle. The pulse detonation combustor 14, shown in FIG. 1 or FIG. 2, includes a combustion, or detonation, chamber 16 having an oxidizer supply section (e.g., an air intake) 30 for feeding an oxidizer (e.g., oxidant such as air) into the combustion chamber 16, a fuel supply section (e.g., a fuel valve) 28 for feeding a fuel into the combustion chamber 16, and an igniter (for instance, a spark plug) 26 by which a mixture of oxidizer combined with the fuel in the combustion chamber 16 is ignited. Although only a pulse detonation combustion and combustion chamber are depicted throughout the accompanying drawings, anticipated by this disclosure is a pulse detonation engine including a plurality of pulse detonation combustors, and therefore a plurality of pulse detonation chambers, each configured as described herein.

In exemplary embodiments, air supplied from an inlet fan 20 and/or a compressor 12, which is driven by a turbine 18, is fed into the combustion chamber 16 through an intake 30. Fresh air is filled in the combustion chamber 16, after purging combustion gases remaining in the combustion chamber 16 due to detonation of the fuel-air mixture from the previous cycle. After the purging the pulse detonation combustor 16, fresh fuel is injected into pulse detonation combustor 16. Next, the igniter 26 ignites the fuel-air mixture forming a flame, which accelerates down the pulse combustion chamber 16, finally transitioning to a detonation wave or a quasi-detonation wave. Due to the detonation combustion heat release, the gases exiting the pulse detonation combustor 14 are at high temperature, high pressure and high velocity conditions, which expand across the turbine 18, located at the downstream of the pulse detonation combustor 14, thus generating positive work. For the pulse detonation turbine engine application with the purpose of generation of power, the pulse detonation driven turbine 18 is mechanically coupled to a generator (e.g., a power generator) 22 for generating power output. For a pulse detonation turbine engine application with the purpose of propulsion (such as the present aircraft engines), the turbine shaft is coupled to the inlet fan 20 and the compressor 12. In a pure pulse detonation engine application of the pulse detonation combustor 14 shown in FIG. 2, which does not contain any rotating parts such as a fan or compressor/turbine/generator, the kinetic energy of the combustion products and the pressure forces acting on the walls of the propulsion system, generate the propulsion force to propel the system.

As previously indicated, pulse detonation combustion is accomplished in the combustion chamber 16. The combustion chamber 16 may include any type of chamber configured for combustion, including shock tubes, resonating detonation cavities and tubular/tuboannular/annular combustors. As used herein, the term “chamber” includes pipes having circular or non-circular cross-sections with constant or varying cross sectional area. Exemplary pulse detonation chambers include cylindrical tubes, as well as tubes having polygonal cross-sections, for example hexagonal tubes.

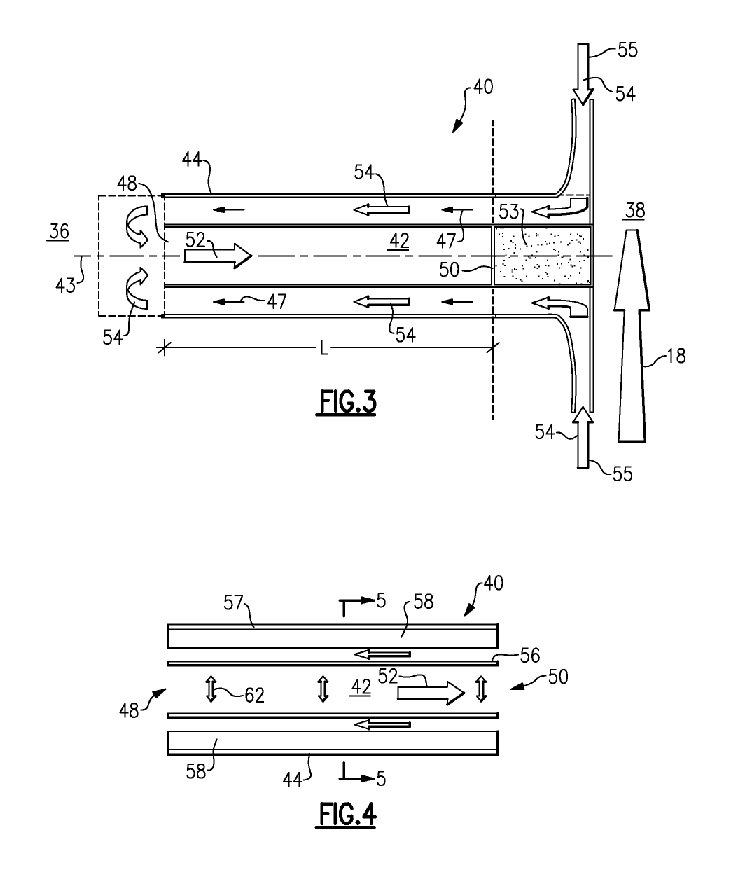

Turning now to FIGS. 3 and 4, illustrated are schematic cross-sectional views of alternate embodiments of an improved pulse detonation combustor, generally depicted as 40, similar to pulse detonation combustor 14 of FIGS. 1 and 2. The schematic views illustrate an inside of an improved pulse detonation combustor 40, including a pulse detonation chamber 42, generally similar to combustion chamber 16 of FIG. 2. More specifically, illustrated are embodiments of the improved pulse detonation combustor 40, including the combustion chamber 42, and a cooling assembly 44, generally comprised of a cooling flow sleeve 46 circumscribing the pulse combustion chamber 42. In the illustrated exemplary embodiment, the combustion chamber 42 is configured having a length “L” and including an inlet 48 and an outlet 50, through which a fluid flows from upstream 36 towards downstream 38, as indicated by the directional arrows 52. The improved pulse combustion combustor 40 includes the cooling flow sleeve 46 concentrically positioned relative to the combustion chamber 42 and about an axis 43, and circumscribing the combustion chamber 42. As indicated by directional arrows, during operation a cooling fluid flow 54 of a discharge air 55 from a compressor, such as compressor 12 (FIG. 1) flows along a plurality of cooling paths 47, of which only one is shown, in reverse flow format and provides cooling, via the cooling flow sleeve 46, to an exterior surface 56 of the combustion chamber 42.

The cooling flow sleeve 46 may be made of a Ni-base superalloy, such as Haynes 188. Depending on temperatures of individual applications, other materials that could be used includes stainless steels, alloys and composites with a Ni-base, Co-base, Fe-base, Ti-base, Cr-base, or Nb-base. An example of a composite is a FeCrAlY metallic matrix reinforced with a W phase, present as particulate, fiber, or laminate.

In the illustrated embodiment of the combustor 40, further included is a transition piece 53 to transition the cooling fluid flow 54, and more particularly the discharge air 55, from an inlet volume (not shown) such as a scroll piece or annulus, to the cooling path 47 around the combustion chamber 42. In an exemplary embodiment, the transition piece 53 directs the cooling fluid flow 54 to impinge on the combustion chamber 42 and into the cooling flow sleeve 46 along the cooling path 47. The transition piece 53 is configured to provide for transition of a complex merging of multiple combustion chambers 42 at their outlets while simultaneously providing for transitioning of the cooling fluid flow 54 to the individual cooling flow sleeves 46.

Referring more specifically to FIG. 4, illustrated is the pulse detonation combustor 40, including the cooling assembly 44. The cooling assembly 44 includes the cooling flow sleeve 46 as previously introduced. The cooling flow sleeve 46 is configured to include a plurality of circumferentially spaced apart axially extending structural members 57, such as a plurality of axially extending rib-like structures 58, integrally formed with the cooling flow sleeve 46 structure. As illustrated in FIG. 4, the plurality of axially extending rib-like structures 58 are not integrally connected to the combustion chamber 42, and configured to be mechanically and thermally separate from the combustion chamber 42. More specifically, the combustion chamber 42 and the cooling flow sleeve 47, while being positioned in close proximity and including a sealing interface at respective axial end portions to prevent loss of the cooling fluid flow 54 from within the cooling flow sleeve 47, are configured mechanically separate from each other and more particularly maintain mechanical separation in terms of not being mechanically joined to each other. For purposes of this disclosure, the term “mechanically separate” is intended to mean that the cooling flow sleeve 47 and the combustion chamber 42 are not joined to one another through any mechanical means, such as welding, brazing, bolting, or through integral fabrication. The plurality of axially extending rib-like structures 58 define a plurality of equal flow passages 60 (FIGS. 5-7) about the detonation chamber 42 along the cooling path 47 through which the cooling fluid flow 54 flows to provide axisymmetric cooling to the combustion chamber 42.

The cooling assembly 44 is preferably designed during a hot phase of operation, and more particularly at a time in which the combustion chamber 42 is at full thermal expansion and mechanical distortion due to pressure changes during a hot phase of combustor operation. More specifically, as illustrated by directional arrows 62, the combustion chamber 42 undergoes thermal expansion during operation relative to the cooling flow sleeve 46. During this stage of operation the combustion chamber 42 expands to come in contact, or near contact, with the plurality of axially extending rib-like structures 58, as described presently.

Referring now to FIGS. 5-7, illustrated are schematic cross-section views taken along line 5-5 of FIG. 4 illustrating the combustion chamber 42 and the cooling assembly 44 during a cold phase of operation, a phase of operation with partial thermal expansion of the combustion chamber 42 and a hot phase of operation with complete thermal expansion of the combustion chamber 42, respectively. Illustrated in FIG. 5 is the combustion chamber 42 during a cold phase of operation, such as during a startup of the pulse detonation engine 10 (FIG. 1). During this stage of operation, the combustion chamber 42 and cooling flow sleeve 46 are separated by a distance, or clearance, “x₁” between the exterior surface 56 of the combustion chamber 42 and the plurality of axially extending rib-like structures 58. As best illustrated in FIG. 5, during this phase of operation the cooling flow passages 60 are larger than during the hot phase of operation, but less cooling magnitude is required.

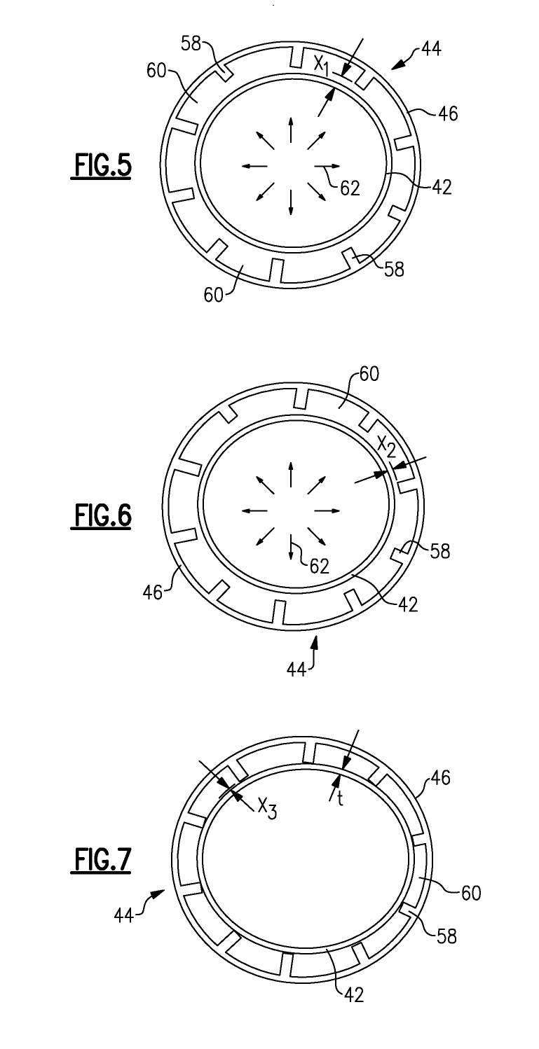

Referring now to FIG. 6, as thermal expansion of the combustion chamber 42 occurs, the volume of each of the cooling flow passages 60 decreases and heat transfer will increase for cooling purposes. During this phase of operation, the plurality of cooling flow passages 60 will assure even flow distribution for cooling purposes. As illustrated in FIG. 6, during this intermediary phase of operation when the combustion chamber 42 has undergone some thermal expansion, the combustion chamber 42 and cooling flow sleeve 46 are separated by a distance, or clearance, “x₂” between the exterior surface 56 of the combustion chamber 42 and the plurality of axially extending rib-like structures 58. The lack of thermal connection between the combustion chamber 42 and the plurality of axially extending rib-like structures 58 eliminates any concerns of thermal stresses at an interface of the combustion chamber 42 and each of the plurality of axially extending rib-like structures 58.

During combustion, or under hot operating conditions, the combustion chamber 42 is at maximum thermal expansion as illustrated in FIG. 7. During this time, the combustion chamber 42 expands to come in contact, or near contact, as indicated by distance, or clearance, “x₃” with the plurality of axially extending rib-like structures 58. Some interference of the combustion chamber 42 and the plurality of axially extending rib-like structures 58 may be allowed during design considerations, as long as the design provides for negligible additional stress to be exerted on the combustion chamber 42. In some instances, interference between the combustion chamber 42 and the plurality of axially extending rib-like structures 58 may be desired to dampen vibrations and periodic pressure loads from the detonations within the combustion chamber 42. In addition, the plurality of axially extending rib-like structures 58 prevent the combustion chamber 42 from expanding too much (e.g. creep) by arresting further expansion of the combustion chamber and may provide for the combustion chamber 42 to be configured having a narrower sidewall thickness, as indicated by thickness “t” of FIG. 7.

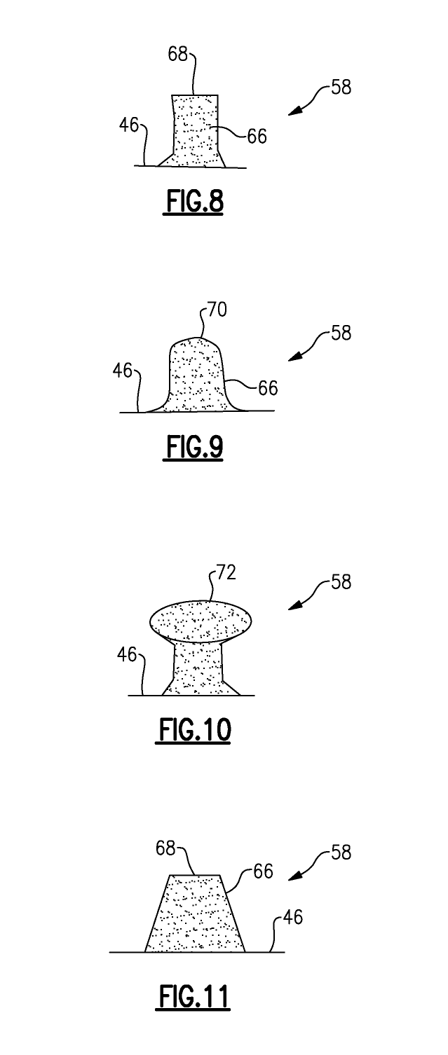

The plurality of axially extending rib-like structures 58 may be configured having various shapes to allow for a soft interference when the combustion chamber 42 is stressed or at full thermal expansion, such as depicted in FIG. 7. Referring now to FIGS. 8-11, illustrated in elevational views are a plurality of shapes in which the plurality of axially extending rib-like structures 58 may be configured, of which only one structure is illustrated in each Figure. FIG. 8 illustrates a single rib-like structure 58 having axially extending straight sides 66 and a planer inner surface 68, wherein the axially extending straight sides 66 are parallel, generally defining a rectangular shape protruding from an interior of the cooling flow sleeve 46. FIG. 9 illustrates a single rib-like structure 58 having axially extending straight sides 66 and a curvilinear inner surface 70, wherein the axially extending straight sides 66 are parallel, generally defining the rib-like structure 58 protruding from an interior of the cooling flow sleeve 46. FIG. 10 illustrates a single rib-like structure 58 having a substantially mushroom shape 72 protruding from an interior of the cooling flow sleeve 46. FIG. 11 illustrates a single rib-like structure 58 having axially extending straight sides 66 and a flat planer surface 68, generally similar to the embodiment depicted in FIG. 8, except in this particular embodiment the axially extending straight sides 66 are not parallel, generally defining a trapezoidal shape protruding from an interior of the cooling flow sleeve 46. Although the plurality of axially extending rib-like structures 58 may be shaped according to any of the previously disclosed embodiments, any interference footprint should be minimized to allow for adequate fluid cooling of the exterior surface 56 of the combustion chamber 42.

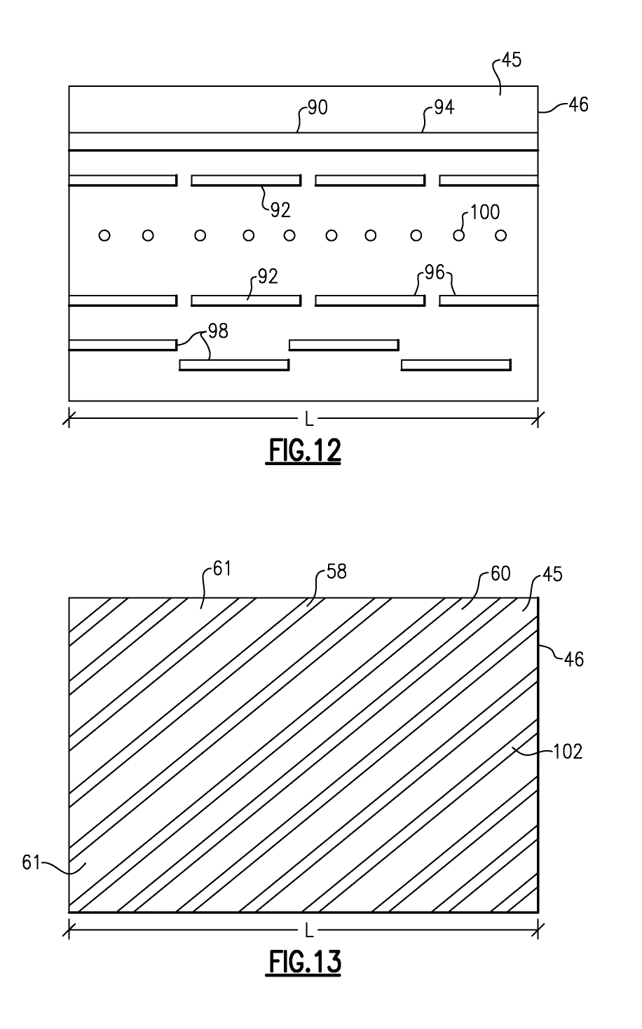

Referring now to FIGS. 12 and 13, illustrated are schematic representations of a plurality of configurations for the rib-like structures 58 along the length “L” of the combustion chamber 42. In an attempt to adequately illustrate the configuration of the plurality of rib-like structures 58, the cooling flow sleeve 46 is partially shown in planar form, prior to rolling into the finished cylindrical shape concentrically aligned with and circumscribing the combustion chamber 42. It should be understood that although a plurality of configurations are illustrated on an interior surface 45 of a single cooling flow sleeve 46, any combination of configurations, or single configuration is contemplated. Accordingly, the rib-like structures 58 may be configured in longitudinally continuous segments 90 along a substantial portion of the length “L” (FIG. 3) of the combustion chamber 42 in an axial direction. Alternatively, the rib-like structures 58 may be configured in longitudinal discontinuous segments 92 along a length “L” (FIG. 3) of the combustion chamber 42 in an axial direction. In addition, the rib-like structures 58 maybe configured in periodic or non-periodic segments along a length “L” (FIG. 3) of the combustion chamber 42 in an axial direction. Additionally, the rib-like structures 58 maybe configured as straight structures 94 along the length “L” (FIG. 3) of the combustion chamber 42 in an axial direction. Lastly, the rib-like structures 58 maybe configured in segments that are in-line 96 or staggered 98 along a length “L” (FIG. 3) of the combustion chamber 42. In yet an alternate embodiment, the structural members 57 may be configured as a series of pins, or bumps, 100 along the length “L” (FIG. 3) of the combustion chamber 42, serving to further augment the cooling at the exterior surface 56 of the combustion chamber 42.

Referring now to FIG. 13, in one particular embodiment, the rib-like structures 58 may be configured at an angle to the axis 43 (FIG. 3), and more particularly as angled rib structures 102 along the length “L” of combustion chamber 42 in an axial direction. The plurality of angled rib structures 102 are fixed for a particular design and balanced with residence time and pressure constraints. In this particular configuration, the angled rib-like structures 102 would form the plurality of equal flow passages 60 in a helical pattern along a substantial portion of the length “L” (FIG. 3) of the combustion chamber 42, thereby forming a plurality of helical flow passages 61 for the cooling fluid flow 54 (FIG. 3). In contrast to the previously disclosed embodiments of the rib-like structures 58, by configuring the rib-like structures 58 at an angle relative to the axis 43 and defining the plurality of helical flow passages 61, provides for an increase in the total distance traveled by the cooling fluid flow 54, and thus an increase in the residence time of the cooling fluid flow 54. The angled rib structure configuration may further provide an increase in a soft interference between the cooling flow sleeve 46, and more particularly the angled rib structures 102, and the combustor chamber 42, as previously described with regard to FIGS. 8-11.

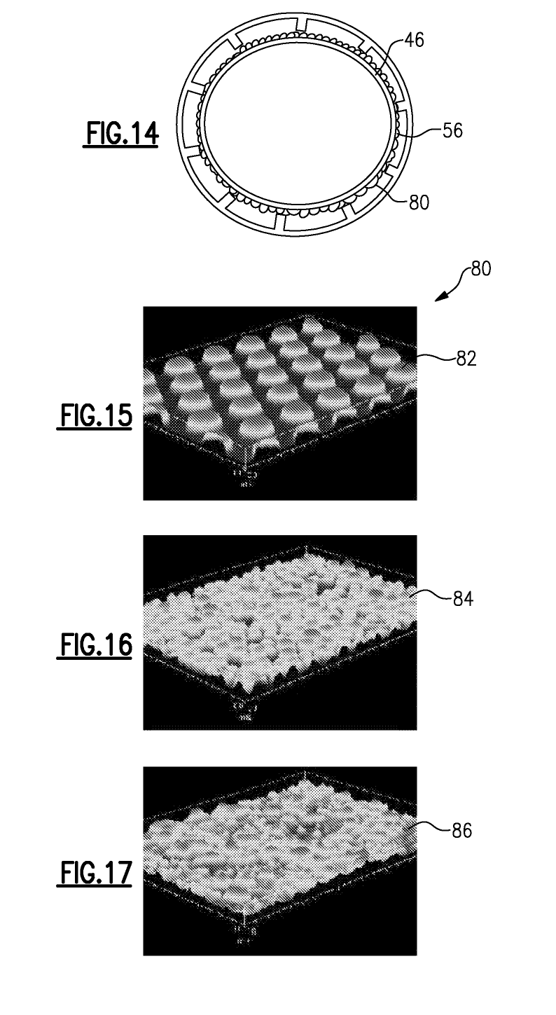

Referring now to FIGS. 14-17, to further provide for cooling of the combustion chamber 42, the exterior surface 56 may be augmented by the use of periodic elements 80, such as a plurality of turbulators, or the like. Augmenting the exterior surface 56 of the combustion chamber 42 increases the surface area of the combustion chamber 42, thereby increasing heat exchange properties of the exterior surface 56. As best illustrated in FIG. 15, the combustion chamber 42, and more particularly the exterior surface 56 of the combustion chamber 42, may be augmented to include a plurality of cast turbulators 82 protruding from the exterior surface 56, a plurality of brazed turbulators 84, as best illustrated in FIG. 16, and/or a plurality of wirespray turbulators 86, as best illustrated in FIG. 17. In addition, the exterior surface 56 of the combustion chamber 42 may include any other surface augmentation, such as pin-fins or applied surface roughness, to increase the exterior surface area of the combustion chamber 42 and provide further cooling of the combustion chamber 42.

Accordingly, by the introduction of relatively simple cooling flow sleeve circumscribing the pulse combustion chamber and aligned coaxial therewith, provides for a significant enhancement in the cooling of the combustion chamber. The cooling flow sleeve provides a plurality of cooling passages and the passage therethrough of a cooling fluid flow from a compressor discharge air in a reverse flow format. The plurality of cooling passages are defined by a plurality of axially extending rib-like structures that may have various configurations represented by various permutations of the various features described above as examples.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A pulse detonation combustor comprising:
a combustion chamber;
a cooling assembly circumscribing said combustion chamber and providing a flow of cooling fluid therethrough,
wherein the cooling assembly is configured mechanically and thermally separate from the combustion chamber and provides axisymmetric cooling to the combustion chamber.

2. The pulse detonation combustor of claim 1, wherein the cooling assembly comprises a cooling flow sleeve positioned about the combustion chamber, the cooling flow sleeve including a plurality of circumferentially spaced apart axially extending structural members defining a plurality of flow passages therebetween.

3. The pulse detonation combustor of claim 2, wherein the plurality of circumferentially spaced apart axially extending structural members are rib-like structures.

4. The pulse detonation combustor of claim 2, wherein the plurality of circumferentially spaced apart axially extending structural members are pins.

5. The pulse detonation combustor of claim 2, wherein the plurality of flow passages are configured to pass equal fluid volumes therethrough.

6. The pulse detonation combustor of claim 1, wherein the cooling flow sleeve is configured in concentric alignment with the combustor chamber.

7. The pulse detonation combustor of claim 1, wherein the cooling assembly is in fluid flow communication with a discharge airflow from a compressor.

8. The pulse detonation combustor of claim 2, wherein each of the plurality of circumferentially spaced apart axially extending structural members is longitudinally continuous along a length of the combustion chamber.

9. The pulse detonation combustor of claim 2, wherein each of the plurality of circumferentially spaced apart axially extending structural members is longitudinally discontinuous along a length of the combustor chamber.

10. The pulse detonation combustor of claim 2, wherein each of the plurality of circumferentially spaced axially extending apart structural members is substantially straight along a length in an axial direction.

11. The pulse detonation combustor of claim 2, wherein each of the plurality of circumferentially spaced axially extending apart structural members is substantially curved along a length in an axial direction.

12. The pulse detonation combustor of claim 2, wherein a portion of the plurality of circumferentially spaced apart axially extending structural members are substantially straight along a length in an axial direction and a portion of the plurality of circumferentially spaced apart structural members are substantially curved along a length in an axial direction.

13. A pulse detonation combustor comprising:
a combustion chamber;
a cooling assembly circumscribing said combustion chamber and providing a flow of cooling fluid therethrough, the cooling assembly including a cooling flow sleeve concentrically aligned with the combustor chamber and having a plurality of circumferentially spaced apart axially extending structural members defining a plurality of flow passages therebetween,
wherein the cooling assembly is configured mechanically and thermally separate from the combustion chamber and provides axisymmetric cooling to the combustion chamber.

14. The pulse detonation combustor of claim 13, wherein the plurality of circumferentially spaced apart axially extending structural members are rib-like structures.

15. The pulse detonation combustor of claim 13, wherein the plurality of flow passages are configured to provide for a fluid flow of an equal volume therethrough.

16. The pulse detonation combustor of claim 13, wherein each of the plurality of circumferentially spaced apart axially extending structural members is longitudinally continuous along a length of the combustion chamber.

17. The pulse detonation combustor of claim 13, wherein each of the plurality of circumferentially spaced apart axially extending structural members is longitudinally discontinuous along a length of the combustion chamber.

18. The pulse detonation combustor of claim 13, wherein each of the plurality of circumferentially spaced apart axially extending structural members is substantially straight along a length in an axial direction.

19. The pulse detonation combustor of claim 13, wherein each of the plurality of circumferentially spaced apart axially extending structural members is substantially curved along a length in an axial direction.

20. The pulse detonation combustor of claim 13, wherein a portion of the plurality of circumferentially spaced apart axially extending structural members are substantially straight along a length in an axial direction and a portion of the plurality of circumferentially spaced apart axially extending structural members are substantially curved along a length in an axial direction.

21. A pulse detonation combustor assembly comprising:
at least one combustion chamber;
an oxidizer supply section for feeding an oxidizer into the combustion chamber;
a fuel supply section for feeding a fuel into the combustion chamber; and
an igniter for igniting a mixture of the gas and the fuel in the combustion chamber; and
a cooling assembly circumscribing said combustion chamber and providing a flow of cooling fluid therethrough, the cooling assembly including a cooling flow sleeve concentrically aligned with the combustor chamber and having a plurality of circumferentially spaced apart axially extending structural members defining a plurality of flow passages therebetween,
wherein the cooling assembly is configured mechanically and thermally separate from the combustion chamber and provides axisymmetric cooling to the combustion chamber.

22. The pulse detonation combustor assembly of claim 21, wherein the plurality of circumferentially spaced apart axially extending structural members are rib-like structures.

23. The pulse detonation combustor assembly of claim 21, wherein the cooling assembly is in fluid flow communication with a discharge airflow from a compressor.
